(19) United States
(12) Patent Application Publication
(10) Pub. No.: US 2026/0086327 A1
(43) Pub. Date: Mar. 26, 2026

(54) CAMERA OPTICAL LENS

(71) Applicant: Changzhou AAC Raytech Optronics Co., Ltd., Changzhou City, (CN)

(72) Inventor: Yongqiang Yang, Changzhou (CN)

(21) Appl. No.: 18/979,691

(22) Filed: Dec. 13, 2024

Related U.S. Application Data
(63) Continuation of application No. PCT/CN2024/120332, filed on Sep. 23, 2024.

(51) Int. Cl. G02B 13/00; G02B 9/62

(52) U.S. Cl. CPC G02B 13/0045; G02B 9/62

(57) ABSTRACT

A camera optical lens sequentially includes six lenses: six lenses from an object-side to an image-side: a first lens having negative refractive power, a second lens having positive refractive power, a third lens having positive refractive power, a fourth lens having negative refractive power, and a fifth lens having positive refractive power, and a sixth lens having negative refractive power. Following relational expressions are satisfied: 3.00≤(f5−f6)/f≤4.00; 2.00≤(d1+d3+d5)/(d2+d4)≤4.50; −1.30≤(R1+R2)/(R1−R2)≤−1.05. The camera optical lens according to the present disclosure has excellent optical characteristics of sufficient aberration correction, large aperture, wide-angle and ultra-thinness, and is particularly suitable for a mobile phone camera lens assembly and a WEB camera lens which are composed of camera elements such as CCD, CMOS with high resolution, and a vehicle-mounted lens.

### CROSS-REFERENCE TO RELATED APPLICATIONS

This application is a continuation of International Application No. PCT/CN2024/120332, filed on Sep. 23, 2024, which is hereby incorporated by reference in its entirety.

### TECHNICAL FIELD

The present disclosure relates to the field of optical lens and, in particular to a camera optical lens applicable to handheld terminal devices such as smart phones, digital cameras, and camera devices such as monitors and PC lenses, vehicle-mounted lenses.

### BACKGROUND

In recent years, with the popularity of various smart devices, the demand for a miniaturized camera optical lens has gradually increased. Moreover, since the pixel size of the optical sensor is reduced, and the current electronic product has a light-thin and portable development trend, the miniaturized camera optical lens with good imaging quality has become the mainstream of the current market. In order to obtain better imaging quality, a multi-lens structure is mostly used. In addition, with the development of technology and the increase of diversified requirements of users, under the condition that the pixel area of the optical sensor is continuously reduced and the requirements on the imaging quality of the system are continuously improved, the six-lens structure gradually appears in the lens design. There is an urgent need for a wide-angle camera lens having excellent optical characteristics such as large aperture, wide-angle, ultra-thinness and sufficiently corrected aberration.

### SUMMARY

In view of the above problems, an object of the present disclosure is to provide a camera optical lens, which has good optical performance and meets design requirements of sufficient aberration correction, large aperture, wide-angle and ultra-thinness.

In order to realize the above object, the technical solution of the present disclosure provides a camera optical lens. The camera optical lens sequentially includes six lenses from an object-side to an image-side: a first lens having negative refractive power, a second lens having positive refractive power, a third lens having positive refractive power, a fourth lens having negative refractive power, a fifth lens having positive refractive power, and a sixth lens having negative refractive power. A focal length of the camera optical lens is f, a focal length of the fifth lens is f5, a focal length of the sixth lens is f6, an on-axis thickness of the first lens is d1, an on-axis thickness of the second lens is d3, an on-axis thickness of the third lens is d5, an on-axis distance from an image-side surface of the first lens to an object-side surface of the second lens is d2, an on-axis distance from an image-side surface of the second lens to an object-side surface of the third lens is d4, a central curvature radius of an object-side surface of the first lens in a paraxial region is R1, and a central curvature radius of an image-side surface of the first lens in the paraxial region is R2, and following relational expressions are satisfied:

$$3. \leq ( f 5 - f 6 ) / f \leq 4. ;$$

$$2. \leq ( d 1 + d 3 + d 5 ) / ( d 2 + d 4 ) \leq 4.5 ;$$

$$- 1.3 \leq ( R 1 + R 2 ) / ( R 1 - R 2 ) \leq - 1.05 .$$

As an improvement, an on-axis distance from an image-side surface of the sixth lens to an image plane is BF; a total optical length from an object-side surface of the first lens to the image plane of the camera optical lens along an optic axis is TTL, and a following relational expression is satisfied:

$$0.15 \leq BF / TTL \leq 0.24 .$$

As an improvement, a central curvature radius of the object-side surface of the fifth lens in a paraxial region is R9, a central curvature radius of the image-side surface of the fifth lens in the paraxial region is R10, and a following relational expression is satisfied:

$$0.55 \leq ( R 9 + R 10 ) / ( R 9 - R 10 ) \leq 0.9 .$$

As an improvement, an object-side surface of the first lens is concave in a paraxial region, and an image-side surface of the first lens is convex in the paraxial region;
a focal length of the first lens is f1, and a total optical length from an object-side surface of the first lens to an image plane of the camera optical lens along an optic axis is TTL, and following relational expressions are satisfied:

$$- 3.64 \leq f 1 / f \leq - 1.05 ;$$

$$and$$

$$0.03 \leq d 1 / TTL \leq 0.11 .$$

As an improvement, an object-side surface of the second lens is convex in a paraxial region, and an image-side surface of the second lens is concave in the paraxial region;
a focal length of the second lens is f2, a central curvature radius of an object-side surface of the second lens in a paraxial region is R3, a central curvature radius of an image-side surface of the second lens in the paraxial region is R4, and a total optical length from an object-side surface of the first lens to an image plane of the camera optical lens along an optic axis is TTL, and following relational expressions are satisfied:

$$2.02 \leq f 2 / f \leq 8.04 ;$$

$$- 19.49 \leq ( R 3 + R 4 ) / ( R 3 - R 4 ) \leq - 4.64 ;$$

$$and$$

$$0.03 \leq d 3 / TTL \leq 0.15 .$$

As an improvement, an object-side surface of the third lens is convex in a paraxial region, and an image-side surface of the third lens is convex in the paraxial region;
a focal length of the third lens is f3, a central curvature radius of an object-side surface of the third lens in a paraxial region is R5, a central curvature radius of the image-side surface of the third lens in the paraxial region is R6, a total optical length from an object-side surface of the first lens to an image plane of the camera optical lens along an optic axis is TTL, and following relational expressions are satisfied:

$$0.52 \leq f 3 / f \leq 1.69 ;$$

$$0.06 \leq ( R 5 + R 6 ) / ( R 5 - R 6 ) \leq 0.23 ;$$

$$and$$

$$0.06 \leq d 5 / TTL \leq 0.24 .$$

As an improvement, an object-side surface of the fourth lens is concave in a paraxial region;
a focal length of the fourth lens is f4, a central curvature radius of an object-side surface of the fourth lens in a paraxial region is R7, a central curvature radius of an image-side surface of the fourth lens in a paraxial region is R8, an on-axis thickness of the fourth lens is d7, and a total optical length from an object-side surface of the first lens to an image plane of the camera optical lens along an optic axis is TTL, and following relational expressions are satisfied:

$$- 6.59 \leq f 4 / f \leq - 2.01 ;$$

$$- 2.08 \leq ( R 7 + R 8 ) / ( R 7 - R 8 ) \leq - 0.64 ;$$

$$0.02 \leq d 7 / TTL \leq 0.07 .$$

As an improvement, an object-side surface of the fifth lens is convex in a paraxial region; an image-side surface of the fifth lens is convex in the paraxial region;
an on-axis thickness of the fifth lens is d9, and a total optical length from an object-side surface of the first lens to an image plane of the camera optical lens along an optic axis is TTL, and following relational expressions are satisfied:

$$0.58 \leq f 5 / f \leq 2.25 ;$$

$$and$$

$$0.07 \leq d 9 / TTL \leq 0.24 .$$

As an improvement, an object-side surface of the sixth lens is convex in a paraxial region, and an image-side surface of the sixth lens is concave in the paraxial region;
a central curvature radius of an object-side surface of the sixth lens in a paraxial region is R11, a central curvature radius of an image-side surface of the sixth lens in the paraxial region is R12, an on-axis thickness of the sixth lens is d11, and a total optical length from an object-side surface of the first lens to an image plane of the camera optical lens along an optic axis is TTL, following relational expressions are satisfied:

$$- 5. \leq f 6 / f \leq - 1.23 ;$$

$$1.39 \leq ( R 11 + R 12 ) / ( R 11 - R 12 ) \leq 4.7 ;$$

$$and$$

$$0.06 \leq d 11 / TTL \leq 0.22 .$$

As an improvement, an aperture of the camera optical lens is FNO, and a following relational expression is satisfied: FNO≤2.27.

The present disclosure has following beneficial effects: the camera optical lens according to the present disclosure has excellent optical characteristics of sufficient aberration correction, large aperture, wide-angle and ultra-thinness, and is particularly suitable for a mobile phone camera lens assembly and a WEB camera lens which are composed of camera elements such as CCD, CMOS with high resolution and a vehicle-mounted lens.

### BRIEF DESCRIPTION OF DRAWINGS

Many aspects of the exemplary embodiment can be better understood with reference to following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a schematic structural diagram of a camera optical lens according to Comparative Example of the present disclosure;

FIG. 18 is a schematic diagram of longitudinal aberration of the camera optical lens shown in FIG. 17;

FIG. 19 is a schematic diagram of lateral color of the camera optical lens shown in FIG. 17; and

FIG. 20 is a schematic diagram of field curvature and distortion of the camera optical lens shown in FIG. 17.

### DESCRIPTION OF EMBODIMENTS

In order to more clearly illustrate objectives, technical solutions, and advantages of the embodiments of the present disclosure, the technical solutions in the embodiments of the present disclosure are clearly and completely described in details with reference to the drawings. However, those of ordinary skill in the art will appreciate that in various embodiments of the present disclosure, numerous technical details are set forth for the reader to better understand the present disclosure. However, even without these technical details and various variations and modifications based on following embodiments, the technical solutions claimed in the present disclosure can still be implemented.

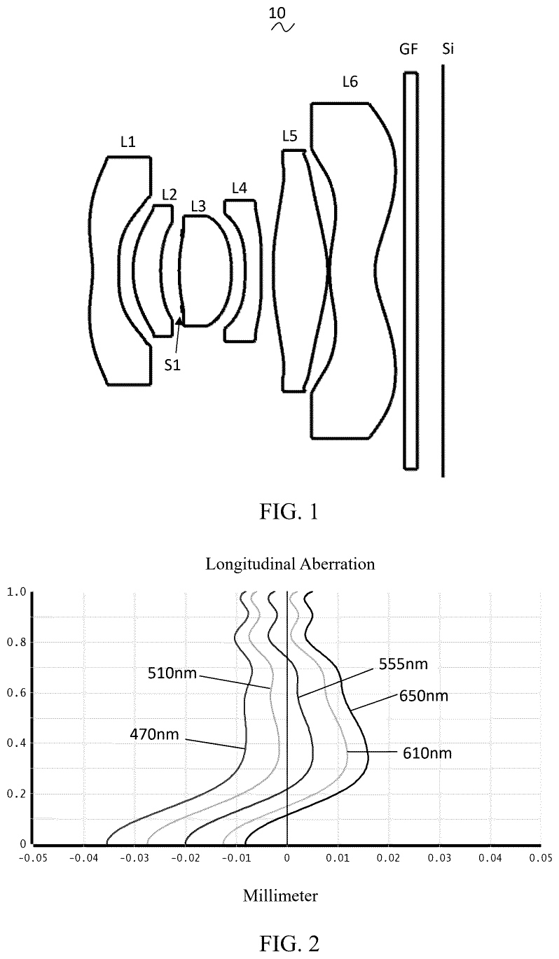

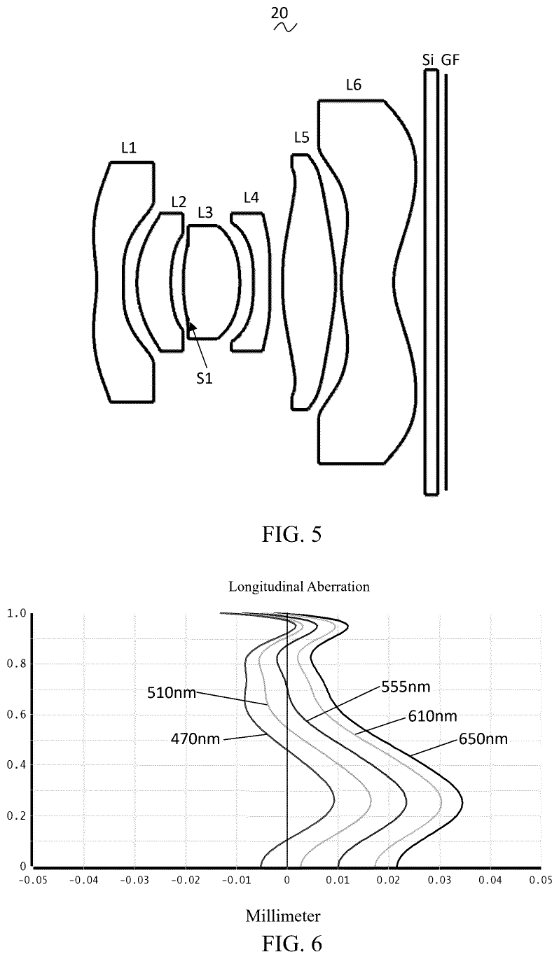

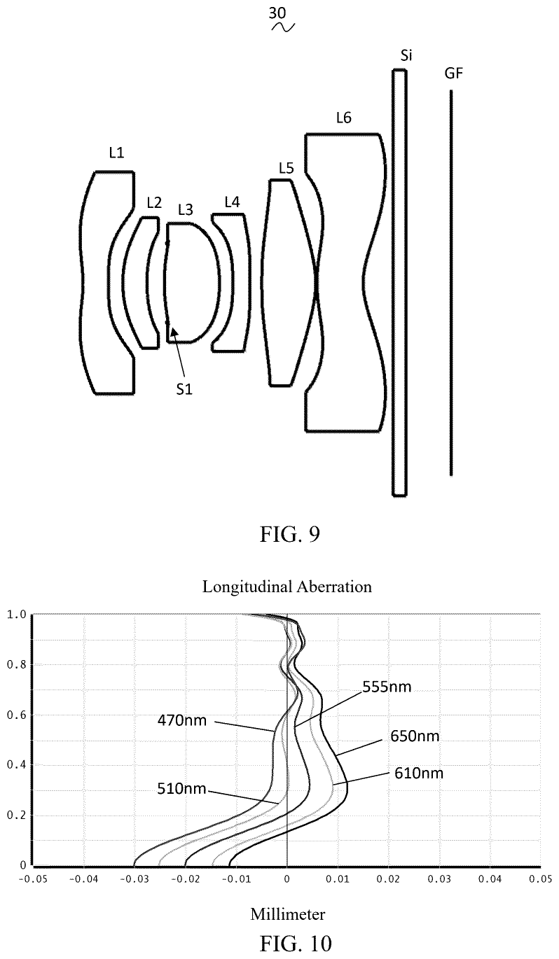

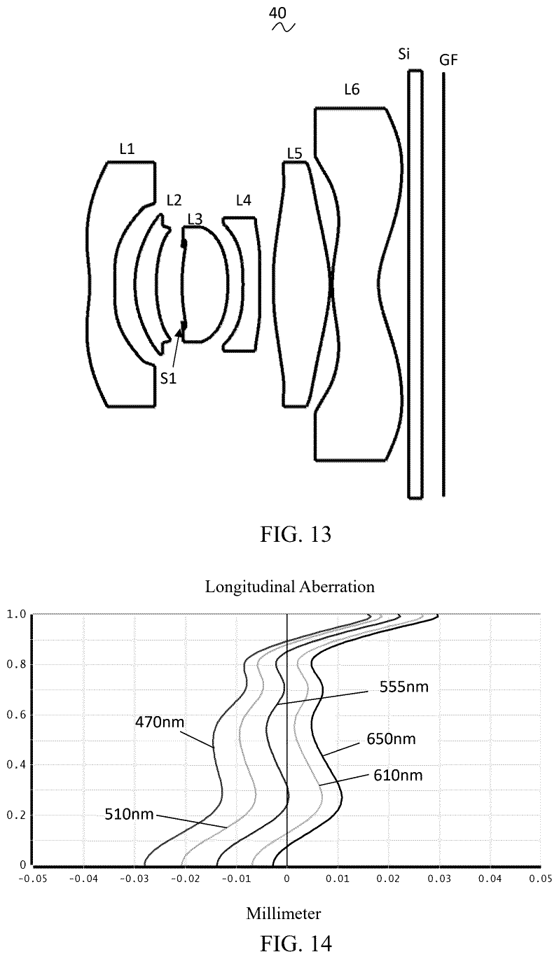

Referring to FIGS. 1-16, the technical solution of the present disclosure provides camera optical lenses 10, 20, 30, 40. FIG. 1, FIG. 5, FIG. 9, and FIG. 13 show camera optical lenses 10, 20, 30, 40 according to the present disclosure, and the camera optical lenses 10, 20, 30, 40 include six lenses. The camera optical lens sequentially includes from an object-side to an image-side: a first lens L1, a second lens L2, an aperture S1, a third lens L3, a fourth lens L4, a fifth lens L5, and a sixth lens L6. An optical element such as a grating filter GF may be provided between the sixth lens L6 and an image plane Si.

The first lens L, the second lens L2, the third lens L3, the fourth lens L4, the fifth lens L5, and the sixth lens L6 are all made of plastic materials. The lenses may be made of other materials.

A focal length of the camera optical lens is defined as f, a focal length of the fifth lens L5 is defined as f5, and a focal length of the sixth lens L6 is defined as f6, and a following relational expression is satisfied: 3.00≤(f5−f6)/f≤4.00. Within the above range of the relational expression, the optical system has better imaging quality and lower sensitivity by reasonably distributing the optical focal length of the optical system.

An on-axis thickness of the first lens L1 is defined as d1, an on-axis thickness of the second lens L2 is defined as d3, an on-axis thickness of the third lens L3 is defined as d5, an on-axis distance from an image-side surface of the first lens L1 to an object-side surface of the second lens L2 is defined as d2, and an on-axis distance from an image-side surface of the second lens L2 to an object-side surface of the third lens L3 is defined as d4, and a following relational expression is satisfied: 2.00≤(d1+d3+d5)/(d2+d4)≤4.50. Within the above range of the relational expression, it is beneficial to correct astigmatism and distortion of the camera optical lens by reasonably allocating the air spacing between the lenses, so that distortion |Distortion|≤5%, thereby reducing the possibility of vignetting generation.

A central curvature radius of the object-side surface of the first lens L1 is defined as R1 in the paraxial region, a central curvature radius of the image-side surface of the first lens L1 is defined as R2 in the paraxial region, and a following relational expression is satisfied: −1.30≤(R1+R2)/(R1−R2)≤−1.05. Within the above range of the relational expression, the shape of the first lens L1 is defined. Within the above range of the relational expression, the degree of deflection of light passing through the lens may be reduced, the chromatic aberration is effectively corrected, and the chromatic aberration |LC|≤3.0 μm.

When the above relational expression is satisfied, the camera optical lenses 10, 20, 30, 40 have good optical performance and may satisfy the design requirements of large aperture, wide-angle and ultra-thinness; according to the characteristics of the camera optical lenses 10, 20, 30, 40, the camera optical lenses 10, 20, 30, 40 are particularly suitable for mobile phone camera lens assemblies and WEB camera lenses composed of camera elements such as CCD and CMOS with high resolution.

Based on the above relational expressions and the achievable functions, the characteristics of each lens are further defined as follows.

An on-axis distance from an image-side surface of the sixth lens L6 to an image surface Si is defined as BF, and a total optical length from an object-side surface of the first lens to an image plane of the camera optical lens along an optic axis is defined as TTL, and a following relational expression is satisfied: 0.15≤BF/TTL≤0.24. Within the above range of the relational expression, the back focal length is reduced on the basis of realizing miniaturization, which not only facilitates assembly of the module, but also may effectively control the total length of the optical system.

A central curvature radius of an object-side surface of the fifth lens L5 in a paraxial region is defined as R9, a central curvature radius of an image-side surface of the fifth lens L5 in the paraxial region is defined as R10, and a following relational expression is satisfied: 0.55≤(R9+R10)/(R9−R10)≤0.90. The shape of the fifth lens L5 is defined. Within the above range of the relational expression, the degree of deflection of light passing through the lens may be reduced, and the aberration is effectively corrected.

An object-side surface of the first lens L1 is concave in a paraxial region, an image-side surface of the first lens L1 is convex in the paraxial region, and the first lens L1 has negative refractive power. The object-side surface and the image-side surface of the first lens L1 may also be provided with other concave and convex distributions.

The focal length of the first lens L1 is f1, and a following relational expression is satisfied: −3.64≤f1/f≤−1.05. It defines a ratio of negative refractive power of the first lens L1 to an overall focal length. Within the above range of the relational expression, the first lens has a proper negative refractive power, which is beneficial to reducing system aberration, while it is beneficial to development of the lens assembly to ultra-thinness and wide-angle. Optionally, a following relational expression is satisfied: −2.27≤f1/f≤−1.31.

A total optical length from the object-side surface of the first lens to an image plane of the camera optical lens along an optic axis is TTL, and the follow relational expression is satisfied: 0.03≤d1/TTL≤0.11. Within the above range of the relational expression, it is beneficial to achieve miniaturization. Optionally, a following relational expression is satisfied:

$$0.06 \leq d 1 / TTL \leq 0.09 .$$

An object-side surface of the second lens L2 is convex in a paraxial region, an image-side surface of the second lens L2 is concave in the paraxial region, and the second lens L2 has positive refractive power. The object-side surface and the image-side surface of the second lens L2 may also be provided with other concave and convex distributions.

A focal length of the second lens L2 is defined as f2, and a following relational expression is satisfied: 2.02≤f2/f≤8.04. It is beneficial to correct the aberration of the optical system by controlling the positive refractive power of the second lens L2 within a reasonable range. Optionally, a following relational expression is satisfied: 3.23≤f2/f<6.44.

A central curvature radius of the object-side surface of the second lens L2 in a paraxial region is R3, a central curvature radius of the image-side surface of the second lens L2 in the paraxial region is R4, and the relational expression is satisfied: −19.49≤(R3+R4)/(R3−R4)≤−4.64. It defines the shape of the second lens L2, within the relational expression, it is beneficial to correct problems such as on-axis chromatic aberration with development of ultra-thinness and wide-angle. Optionally, a following relational expression is satisfied:

$$12.18 \leq ( R 3 + R 4 ) / ( R 3 - R 4 ) \leq - 5.8 .$$

The on-axis thickness d3 of the second lens L2 and the total optical length TTL of the camera optical lens satisfy following relational expression: 0.03≤d3/TTL≤0.15. Within the above range of the relational expression, it is beneficial to achieve miniaturization. Optionally, a following relational expression is satisfied: 0.05≤d3/TTL≤0.12.

An object-side surface of the third lens L3 is convex in a paraxial region, an image-side surface of the third lens L3 is convex in the paraxial region, and the third lens L3 has positive refractive power. The object-side surface and the image-side surface of the third lens L3 may also be provided with other concave and convex distributions.

A focal length of the third lens L3 is defined as f3, and a following relational expression is satisfied: 0.52≤f3/f≤1.69. The system has better imaging quality and lower sensitivity by reasonable distribution of refractive power. Optionally, a following relational expression is satisfied: 0.84≤f3/f≤1.35.

A central curvature radius of the object-side surface of the third lens L3 in a paraxial region is defined as R5, a central curvature radius of the image-side surface of the third lens L3 in the paraxial region is defined as R6, and a following relational expression is satisfied: 0.06≤(R5+R6)/(R5−R6)≤0.23. Within the above range of the relational expression, the shape of the third lens L3 may be effectively controlled, and it is beneficial for molding of the third lens L3, and poor molding and stress generation caused by excessive surface curvature of the third lens L3 are avoided. Optionally, a following relational expression is satisfied:

$$0.1 \leq ( R 5 + R 6 ) / ( R 5 - R 6 ) \leq 0.19 .$$

The on-axis thickness d5 of the third lens L3 and the total optical length TTL of the camera optical lens satisfy following relational expression: 0.06≤d5/TTL≤0.24. Within the above range of the relational expression, it is beneficial to achieve miniaturization. Optionally, a following relational expression is satisfied: 0.10≤d5/TTL≤0.19.

An object-side surface of the fourth lens L4 is concave in a paraxial region, an image-side surface of the fourth lens L4 is convex or concave in the paraxial region, and the fourth lens L4 has negative refractive power. The object-side surface of the fourth lens L4 may also be provided with other concave and convex distributions.

A focal length of the fourth lens L4 is defined as f4, and a following relational expression is satisfied: −6.59≤f4/f≤−2.01, the system has better imaging quality and lower sensitivity by reasonable distribution of refractive power. Optionally, a following relational expression is satisfied: −4.12≤f4/f≤−2.51.

A central curvature radius of the object-side surface of the fourth lens L4 in a paraxial region is R7, and a central curvature radius of the image-side surface of the fourth lens L4 in the paraxial region is R8, and a following relational expression is satisfied: −2.08≤(R7+R8)/(R7−R8)≤−0.64, it defines the shape of the fourth lens L4. Within the above range of the relational expression, it is beneficial to correct the aberration of off-axis chromatic angles with the development of ultra-thinness and wide-angle. Optionally, a following relational expression is satisfied: −1.30≤(R7+R8)/(R7−R8)≤−0.80.

An on-axis thickness of the fourth lens L4 is d7, and a following relational expression is satisfied: 0.02≤d7/TTL≤0.07. Within the range of the relational expression, it is beneficial to achieve miniaturization. Optionally, a following relational expression is satisfied:

$$0.04 \leq d 7 / TTL \leq 0.06 .$$

An object-side surface of the fifth lens L5 is convex in a paraxial region, an image-side surface of the fifth lens L5 is convex in the paraxial region, and the fifth lens L5 has positive refractive power. The object-side surface and the image-side surface of the fifth lens L5 may also be provided with other concave and convex distributions.

The focal length f of the camera optical lens and the focal length f5 of the fifth lens L5 satisfy following relational expression: 0.58≤f5/f≤2.25. The limitation of the fifth lens L5 may effectively make a light angle of the camera lens smooth, and reduce tolerance sensitivity. Optionally, a following relational expression is satisfied: 0.92≤f5/f≤1.80.

An on-axis thickness of the fifth lens L5 is d9, and a following relational expression is satisfied: 0.07≤d9/TTL≤0.24. Within the above range of the relational expression, it is beneficial to achieve miniaturization. Optionally, a following relational expression is satisfied:

$$0.12 \leq d 9 / TTL \leq 0.19 .$$

The focal length f of the camera optical lens and the focal length f6 of the sixth lens L6 satisfy following relational expression: −5.00≤f6/f≤−1.23, the system has better imaging quality and lower sensitivity by reasonable distribution of refractive power. Optionally, a following relational expression is satisfied: −3.12≤f6/f≤−1.54.

A central curvature radius of the object-side surface of the sixth lens L6 in a paraxial region is R11, a central curvature radius of the image-side surface of the sixth lens L6 in the paraxial region is R12, and a following relational expression is satisfied: 1.39≤(R11+R12)/(R11−R12)≤4.70, it defines the shape of the sixth lens L6, within the relational expression, it is beneficial to correct the aberration of off-axis chromatic angle and other problems with the development of ultra-thinness and wide-angle. Optionally, a following relational expression is satisfied: 2.23≤(R11+R12)/(R11−R12)≤3.76.

An on-axis thickness of the sixth lens L6 is d11, and a following relational expression is satisfied: 0.06≤d11/TTL≤0.22. Within the above range of the relational expression, it is beneficial to achieve miniaturization. Optionally, a following relational expression is satisfied: 0.10≤d11/TTL≤0.18.

An F-number FNO of the camera optical lens is less than or equal to 2.27, thereby achieving a large aperture and good imaging performance of the camera optical lens.

The camera optical lens of the present disclosure will be described below with examples. The reference signs recited in each examples are shown below. The units of focal length, on-axis distance, central curvature radius and on-axis thickness are mm.

TTL: a total optical length (an on-axis distance from an object-side surface of the first lens L1 to an image plane Si of the camera optical lens along an optic axis) is in mm;

F-number FNO refers to a ratio of the effective focal length of the camera optical lens to an entrance pupil diameter of the camera optical lens.

The technical solutions of the present disclosure will be described in detail in following five Examples.

### Example 1

Table 1 and Table 2 show design data of the camera optical lens 10 according to Example 1 of the present disclosure.

TABLE 1

| | R | d | | nd | | νd | |
|---|---|---|---|---|---|---|---|
| S1 | ∞ | d0= | −1.511 | | | | |
| R1 | −1.770 | d1= | 0.442 | nd1 | 1.5444 | ν1 | 55.82 |
| R2 | −30.734 | d2= | 0.240 | | | | |
| R3 | 1.772 | d3= | 0.465 | nd2 | 1.6153 | ν2 | 25.94 |
| R4 | 2.367 | d4= | 0.312 | | | | |
| R5 | 2.811 | d5= | 0.882 | nd3 | 1.5444 | ν3 | 55.82 |
| R6 | −2.166 | d6= | 0.230 | | | | |
| R7 | −4.805 | d7= | 0.270 | nd4 | 1.6700 | ν4 | 19.39 |
| R8 | 400.000 | d8= | 0.204 | | | | |
| R9 | 12.779 | d9= | 0.919 | nd5 | 1.5444 | ν5 | 55.82 |
| R10 | −1.698 | d10= | 0.031 | | | | |
| R11 | 2.152 | d11= | 0.766 | nd6 | 1.6400 | ν6 | 23.54 |
| R12 | 1.081 | d12= | 0.500 | | | | |
| R13 | ∞ | d13= | 0.210 | ndg | 1.5168 | νg | 64.17 |
| R14 | ∞ | d14= | 0.436 | | | | |

The meaning of each reference sign is as follows.
S1: aperture;
R: curvature radius at the center of the optical surface;
R1: central curvature radius of the object-side surface of the first lens L1 in the paraxial region;
R2: central curvature radius of the image-side surface of the first lens L1 in the paraxial region;
R3: central curvature radius of the object-side surface of the second lens L2 in the paraxial region;
R4: central curvature radius of the image-side surface of the second lens L2 in the paraxial region;
R5: central curvature radius of the object-side surface of the third lens L3 in the paraxial region;
R6: central curvature radius of the image-side surface of the third lens L3 in the paraxial region;
R7: central curvature radius of the object-side surface of the fourth lens L4 in the paraxial region;
R8: central curvature radius of the image-side surface of the fourth lens L4 in the paraxial region;
R9: central curvature radius of the object-side surface of the fifth lens L5 in the paraxial region;
R10: central curvature radius of the image-side surface of the fifth lens L5 in the paraxial region;
R11: central curvature radius of the object-side surface of the sixth lens L6 in the paraxial region; R12: central curvature radius of the image-side surface of the sixth lens L6 in the paraxial region;
R13: central curvature radius of the object-side surface of the grating filter GF in the paraxial region;
R14: central curvature radius of the image-side surface of the grating filter GF in the paraxial region;
d: on-axis thickness of lenses, on-axis distance between lenses;
do: on-axis distance from aperture S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the grating filter GF;
d13: on-axis thickness of the grating filter GF;
d14: on-axis distance from the image-side surface of the grating filter GF to the image plane Si;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
ndg: refractive index of d line of grating filter GF;
vd: abbe number;
v1: abbe number of the first lens L1;
v2: abbe number of the second lens L2;
v3: abbe number of the third lens L3;
v4: abbe number of the fourth lens LA;
v5: abbe number of the fifth lens L5;
v6: abbe number of the sixth lens L6;
vg: abbe number of grating filter GF.

Table 2 shows aspherical surface data of each lens in the camera optical lens 10 according to Example 1 of the present disclosure.

TABLE 2

| | Conic Coefficient | Aspherical Coefficient | | | | |
|---|---|---|---|---|---|---|
| | k | A4 | A6 | A8 | A10 | A12 |
| R1 | −2.33901E+01 | 2.01710E−01 | −2.89170E−02 | −4.59150E−01 | 1.13140E+00 | −1.55090E+00 |
| R2 | 8.78628E+01 | 1.04540E+00 | −3.14000E+00 | 1.41170E+01 | −5.89010E+01 | 1.85380E+02 |
| R3 | −3.85806E+00 | 3.73160E−01 | −6.85440E−01 | −4.83310E+00 | 6.20710E+01 | −3.48990E+02 |
| R4 | 4.78746E+00 | 8.64880E−02 | −9.88810E−01 | 1.34500E+01 | −1.35420E+02 | 9.34350E+02 |
| R5 | 7.20653E+00 | −6.04700E−02 | 1.27960E+00 | −2.89750E+01 | 3.27150E+02 | −1.69130E+03 |
| R6 | −8.54834E−02 | −2.23530E−01 | 7.90300E−01 | −1.29600E+01 | 1.27310E+02 | −8.24160E+02 |
| R7 | 1.73409E+01 | −3.27460E−01 | 1.24170E+00 | −2.52120E+01 | 2.46430E+02 | −1.46680E+03 |
| R8 | −9.90000E+01 | 6.99180E−02 | −1.48420E+00 | 3.58710E+00 | 3.11300E+00 | −5.16720E+01 |
| R9 | 3.67473E+00 | 4.22480E−01 | −1.26860E+00 | 2.41150E+00 | −3.33520E+00 | 3.44500E+00 |
| R10 | −2.38291E+00 | 2.73080E−01 | −5.32270E−01 | 1.14990E+00 | −2.02880E+00 | 2.47990E+00 |
| R11 | 2.51965E−03 | −1.00160E−01 | −3.29410E−01 | 1.02730E+00 | −1.91380E+00 | 2.38750E+00 |
| R12 | −4.28680E+00 | −1.22580E−01 | 1.28570E−01 | −1.30350E−01 | 9.75300E−02 | −5.20070E−02 |

| | Conic Coefficient | Aspherical Coefficient | | | | |
|---|---|---|---|---|---|---|
| | k | A14 | A16 | A18 | A20 | A22 |
| R1 | −2.33901E+01 | 1.42130E+00 | −9.16020E−01 | 4.21470E−01 | −1.37880E−01 | 3.13470E−02 |
| R2 | 8.78628E+01 | −4.25430E+02 | 7.10900E+02 | −8.62870E+02 | 7.51770E+02 | −4.57570E+02 |
| R3 | −3.85806E+00 | 1.21910E+03 | −2.86800E+03 | 4.67360E+03 | −5.29130E+03 | 4.08620E+03 |
| R4 | 4.78746E+00 | −4.37300E+03 | 1.39780E+04 | −3.04730E+04 | 4.45360E+04 | −4.17580E+04 |
| R5 | 7.20653E+00 | −1.59730E+03 | 7.69430E+04 | −4.93190E+05 | 1.64950E+06 | −3.18250E+06 |
| R6 | −8.54834E−02 | 3.68880E+03 | −1.17090E+04 | 2.65460E+04 | −4.26680E+04 | 4.74720E+04 |
| R7 | 1.73409E+01 | 5.90630E+03 | −1.67390E+04 | 3.38010E+04 | −4.83700E+04 | 4.79110E+04 |
| R8 | −9.90000E+01 | 1.96730E+02 | −4.49380E+02 | 6.90600E+02 | −7.31030E+02 | 5.26510E+02 |
| R9 | 3.67473E+00 | −2.65590E+00 | 1.51670E+00 | −6.34260E−01 | 1.90420E−01 | −3.95520E−02 |
| R10 | −2.38291E+00 | −2.08990E+00 | 1.24870E+00 | −5.39440E−01 | 1.68520E−01 | −3.71930E−02 |
| R11 | 2.51965E−03 | −2.07200E+00 | 1.27700E+00 | −5.60860E−01 | 1.73560E−01 | −3.68200E−02 |
| R12 | −4.28680E+00 | 1.98150E−02 | −5.39120E−03 | 1.03890E−03 | −1.39310E−04 | 1.25720E−05 |

| | Conic Coefficient | Aspherical Coefficient | | | | |
|---|---|---|---|---|---|---|
| | k | A24 | A26 | A28 | A30 | / |
| R1 | −2.33901E+01 | −4.71160E−03 | 4.21160E−04 | −1.69650E−05 | / | / |
| R2 | 8.78628E+01 | 1.84500E+02 | −4.42200E+01 | 4.76260E+00 | / | / |
| R3 | −3.85806E+00 | −2.05330E+03 | 6.05340E+02 | −7.94780E+01 | / | / |
| R4 | 4.78746E+00 | 2.27490E+04 | −5.49930E+03 | 0.00000E+00 | / | / |
| R5 | 7.20653E+00 | 3.35920E+06 | −1.50760E+06 | 0.00000E+00 | / | / |
| R6 | −8.54834E−02 | −3.47620E+04 | 1.50730E+04 | −2.93290E+03 | / | / |
| R7 | 1.73409E+01 | −3.12210E+04 | 1.20330E+04 | −2.07730E+03 | / | / |
| R8 | −9.90000E+01 | −2.46600E+02 | 6.77350E+01 | −8.27920E+00 | / | / |
| R9 | 3.67473E+00 | 5.29480E−03 | −3.94850E−04 | 1.12550E−05 | / | / |
| R10 | −2.38291E+00 | 5.49000E−03 | −4.84520E−04 | 1.92610E−05 | / | / |
| R11 | 2.51965E−03 | 5.08110E−03 | −4.09960E−04 | 1.46550E−05 | / | / |
| R12 | −4.28680E+00 | −7.17550E−07 | 2.28400E−08 | −2.94720E−10 | / | / |

For convenience, the aspherical surface of each lens surface uses the aspherical surface shown in following formula (1). However, the present disclosure is not limited to the aspherical polynomial form shown in formula (1).

$$z = ( {cr}^{2} ) / \{ 1 + {[ 1 - ( k + 1 ) ( {c}^{2} {r}^{2} ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

Where, k is a conic coefficient, A4, A6, A8, A10, A12, A14, A16, A18, A20, A22, A24, A26, A28 and A30 are aspherical coefficients, c is a curvature at a center of an optical surface, r is a vertical distance between a point on an aspherical curve and an optical axis, and z is an aspherical depth (a vertical distance between a point on the aspherical surface having a distance r from the optical axis, and a tangent plane tangent to a vertex on the aspherical optical axis).

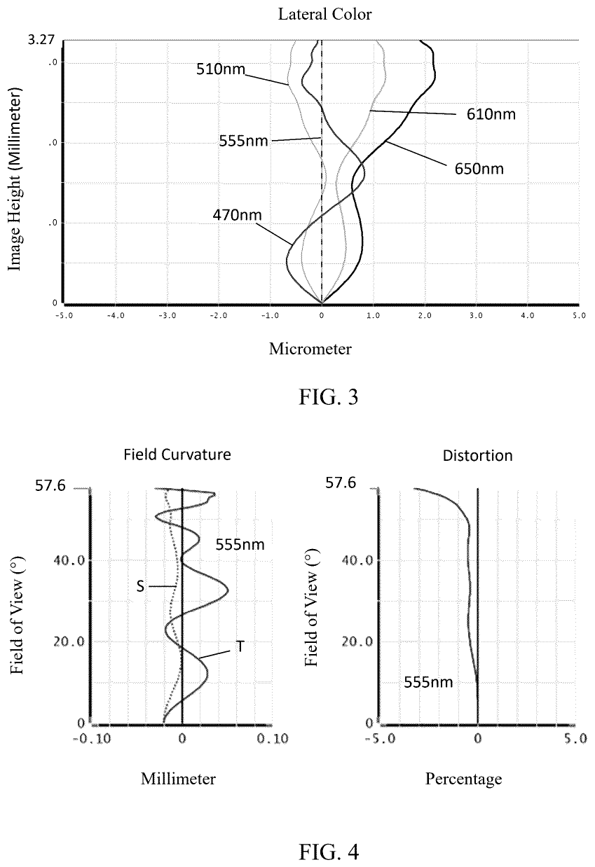

FIG. 2 and FIG. 3 respectively show longitudinal aberration and lateral color of light with wavelengths of 650 nm, 610 nm, 555 nm, 510 nm, and 470 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in the sagittal direction, and T is a field curvature in the meridian direction.

In this example, an entrance pupil diameter ENPD of the camera optical lens 10 is 0.968 mm, a full field of view (1.0 field of view) image height IH is 3.269 mm, and a field of view FOV in a diagonal direction of the full field of view (1.0 field of view) is 115.21°. The camera optical lens 10 meets the design requirements of large aperture, wide-angle and ultra-thinness, its on-axis and off-axis chromatic aberrations are fully corrected. The camera optical lens 10 has excellent optical characteristics.

It may be understood that the 1.0 field of view image height refers to half of the diagonal length of an effective pixel area of the sensor; the FOV in the diagonal direction of the 1.0 field of view refers to the field of view corresponding to the effective pixel area of the sensor.

### Example 2

The meaning of the reference signs of Example 2 is the same as that of Example 1.

FIG. 5 shows a camera optical lens 20 according to Example 2 of the present disclosure.

Table 3 and Table 4 show design data of the camera optical lens 20 according to Example 2 of the present disclosure.

TABLE 3

| | R | d | | nd | | νd | |
|---|---|---|---|---|---|---|---|
| S1 | ∞ | d0= | −1.468 | | | | |
| R1 | −1.753 | d1= | 0.429 | nd1 | 1.5444 | ν1 | 55.82 |
| R2 | −70.433 | d2= | 0.219 | | | | |
| R3 | 1.696 | d3= | 0.549 | nd2 | 1.6153 | ν2 | 25.94 |
| R4 | 2.193 | d4= | 0.202 | | | | |
| R5 | 2.650 | d5= | 0.916 | nd3 | 1.5444 | ν3 | 55.82 |
| R6 | −1.934 | d6= | 0.222 | | | | |
| R7 | −4.340 | d7= | 0.265 | nd4 | 1.6700 | ν4 | 19.39 |
| R8 | −218.375 | d8= | 0.206 | | | | |
| R9 | 7.649 | d9= | 0.860 | nd5 | 1.5444 | ν5 | 55.82 |
| R10 | −2.133 | d10= | 0.091 | | | | |
| R11 | 2.157 | d11= | 0.848 | nd6 | 1.6400 | ν6 | 23.54 |
| R12 | 1.114 | d12= | 0.510 | | | | |
| R13 | ∞ | d13= | −0.034 | ndg | 1.5168 | νg | 64.17 |
| R14 | ∞ | d14= | 0.373 | | | | |

Table 4 shows aspherical surface data of each lens in the camera optical lens 20 according to Example 2 of the present disclosure.

TABLE 4

| | Conic Coefficient | Aspherical Coefficient | | | | |
|---|---|---|---|---|---|---|
| | k | A4 | A6 | A8 | A10 | A12 |
| R1 | −2.35263E+01 | 2.01280E−01 | −2.88870E−02 | −4.59160E−01 | 1.13140E+00 | −1.55090E+00 |
| R2 | 2.14059E+03 | 1.04530E+00 | −3.14020E+00 | 1.41180E+01 | −5.89020E+01 | 1.85380E+02 |
| R3 | −3.95700E+00 | 3.74860E−01 | −6.83530E−01 | −4.83260E+00 | 6.20740E+01 | −3.48990E+02 |
| R4 | 5.02743E+00 | 8.95540E−02 | −9.55590E−01 | 1.35320E+01 | −1.35330E+02 | 9.34300E+02 |
| R5 | 8.54057E+00 | −3.79860E−02 | 1.25440E+00 | −2.90130E+01 | 3.27280E+02 | −1.69110E+03 |
| R6 | 3.79329E−01 | −2.32820E−01 | 8.02120E−01 | −1.29470E+01 | 1.27300E+02 | −8.24150E+02 |
| R7 | 1.59450E+01 | −3.31920E−01 | 1.23330E+00 | −2.52150E+01 | 2.46420E+02 | −1.46680E+03 |
| R8 | 3.79551E+04 | 6.70060E−02 | −1.48550E+00 | 3.58540E+00 | 3.11130E+00 | −5.16730E+01 |
| R9 | −8.75445E+00 | 4.19750E−01 | −1.26910E+00 | 2.41150E+00 | −3.33520E+00 | 3.44500E+00 |
| R10 | −2.16697E+00 | 2.70380E−01 | −5.32800E−01 | 1.14980E+00 | −2.02880E+00 | 2.47990E+00 |
| R11 | −1.90443E−03 | −1.00260E−01 | −3.29850E−01 | 1.02720E+00 | −1.91380E+00 | 2.38750E+00 |
| R12 | −4.06067E+00 | −1.21550E−01 | 1.28560E−01 | −1.30370E−01 | 9.75290E−02 | −5.20070E−02 |

| | Conic Coefficient | Aspherical Coefficient | | | | |
|---|---|---|---|---|---|---|
| | k | A14 | A16 | A18 | A20 | A22 |
| R1 | −2.35263E+01 | 1.42130E+00 | −9.16020E−01 | 4.21470E−01 | −1.37880E−01 | 3.13470E−02 |
| R2 | 2.14059E+03 | −4.25430E+02 | 7.10900E+02 | −8.62870E+02 | 7.51770E+02 | −4.57570E+02 |
| R3 | −3.95700E+00 | 1.21910E+03 | −2.86800E+03 | 4.67360E+03 | −5.29130E+03 | 4.08620E+03 |
| R4 | 5.02743E+00 | −4.37310E+03 | 1.39780E+04 | −3.04730E+04 | 4.45380E+04 | −4.17520E+04 |
| R5 | 8.54057E+00 | −1.59700E+03 | 7.69430E+04 | −4.93190E+05 | 1.64940E+06 | −3.18250E+06 |
| R6 | 3.79329E−01 | 3.68890E+03 | −1.17090E+04 | 2.65460E+04 | −4.26680E+04 | 4.74720E+04 |
| R7 | 1.59450E+01 | 5.90630E+03 | −1.67390E+04 | 3.38010E+04 | −4.83700E+04 | 4.79110E+04 |
| R8 | 3.79551E+04 | 1.96730E+02 | −4.49380E+02 | 6.90600E+02 | −7.31030E+02 | 5.26510E+02 |
| R9 | −8.75445E+00 | −2.65590E+00 | 1.51670E+00 | −6.34260E−01 | 1.90420E−01 | −3.95520E−02 |
| R10 | −2.16697E+00 | −2.08990E+00 | 1.24870E+00 | −5.39440E−01 | 1.68520E−01 | −3.71930E−02 |
| R11 | −1.90443E−03 | −2.07200E+00 | 1.27700E+00 | −5.60860E−01 | 1.73560E−01 | −3.68200E−02 |
| R12 | −4.06067E+00 | 1.98150E−02 | −5.39120E−03 | 1.03890E−03 | −1.39310E−04 | 1.25720E−05 |

| | Conic Coefficient | Aspherical Coefficient | | | | |
|---|---|---|---|---|---|---|
| | k | A24 | A26 | A28 | A30 | / |
| R1 | −2.35263E+01 | −4.71160E−03 | 4.21160E−04 | −1.69640E−05 | 7.30900E−11 | / |
| R2 | 2.14059E+03 | 1.84500E+02 | −4.42200E+01 | 4.76260E+00 | 9.08430E−06 | / |
| R3 | −3.95700E+00 | −2.05330E+03 | 6.05340E+02 | −7.94790E+01 | −4.95520E−04 | / |
| R4 | 5.02743E+00 | 2.27550E+04 | −5.50180E+03 | −2.46780E+01 | −7.35900E+01 | / |
| R5 | 8.54057E+00 | 3.35900E+06 | −1.50760E+06 | 4.65720E+02 | 3.31230E+03 | / |
| R6 | 3.79329E−01 | −3.47620E+04 | 1.50720E+04 | −2.93280E+03 | 7.18700E−01 | / |
| R7 | 1.59450E+01 | −3.12210E+04 | 1.20330E+04 | −2.07720E+03 | 1.32910E−02 | / |
| R8 | 3.79551E+04 | −2.46600E+02 | 6.77350E+01 | −8.27920E+00 | 4.17650E−05 | / |
| R9 | −8.75445E+00 | 5.29480E−03 | −3.94850E−04 | 1.12550E−05 | 3.91670E−11 | / |
| R10 | −2.16697E+00 | 5.48990E−03 | −4.84520E−04 | 1.92610E−05 | −4.48950E−12 | / |
| R11 | −1.90443E−03 | 5.08110E−03 | −4.09960E−04 | 1.46550E−05 | 2.10860E−12 | / |
| R12 | −4.06067E+00 | −7.17550E−07 | 2.28400E−08 | −2.94720E−10 | −3.33910E−16 | / |

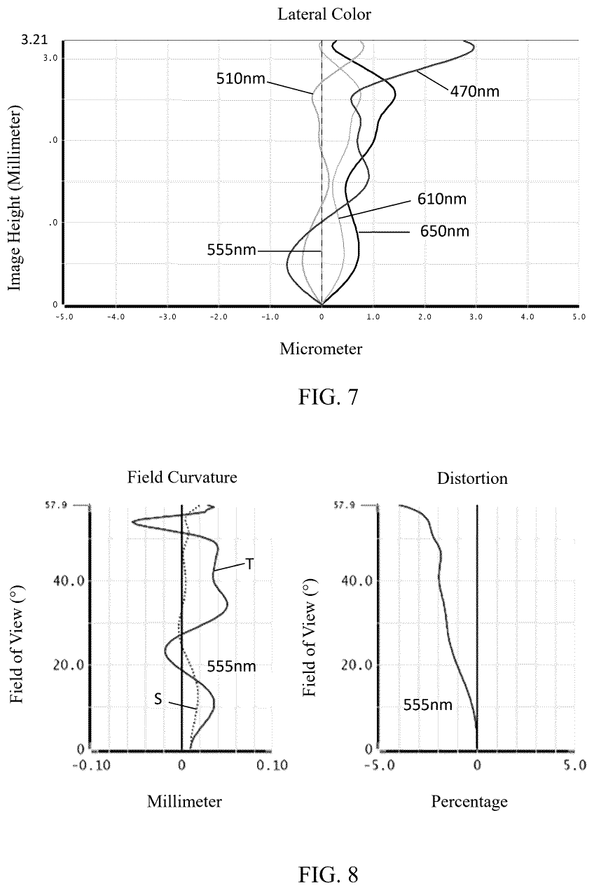

FIG. 6 and FIG. 7 respectively show longitudinal aberration and lateral color of light with wavelengths of 650 nm, 610 nm, 555 nm, 510 nm, and 470 nm after passing through the camera optical lens 20 according to Example 2. FIG. 8 shows field curvature and distortion of light with a wavelength of 555 nm after passing through the camera optical lens 20 according to Example 2. The field curvature S in FIG. 8 is the field curvature in the sagittal direction, and T is the field curvature in the meridian direction.

In this example, the entrance pupil diameter ENPD of the camera optical lens 20 is 0.956 mm, the full field of view (1.0 field of view) image height IH is 3.210 mm, and the field of view FOV in the diagonal direction of the full field of view (1.0 field of view) is 115.88°; the camera optical lens 20 meets the design requirements of large aperture, wide-angle and ultra-thinness, and the on-axis and off-axis chromatic aberration thereof are fully corrected. The camera optical lens 20 has good optical characteristics.

### Example 3

The meaning of the reference signs of Example 3 is the same as that of Example 1.

FIG. 9 shows a camera optical lens 30 according to Example 3 of the present disclosure.

Table 5 and Table 6 show design data of the camera optical lens 30 according to the Example 3 of the present disclosure.

TABLE 5

| | R | d | | nd | | νd | |
|---|---|---|---|---|---|---|---|
| S1 | ∞ | d0= | −1.366 | | | | |
| R1 | −1.830 | d1= | 0.415 | nd1 | 1.5444 | ν1 | 55.82 |
| R2 | −18.517 | d2= | 0.230 | | | | |
| R3 | 1.867 | d3= | 0.390 | nd2 | 1.6153 | ν2 | 25.94 |
| R4 | 2.294 | d4= | 0.282 | | | | |
| R5 | 2.873 | d5= | 0.894 | nd3 | 1.5444 | ν3 | 55.82 |
| R6 | −2.180 | d6= | 0.217 | | | | |
| R7 | −4.658 | d7= | 0.273 | nd4 | 1.6700 | ν4 | 19.39 |
| R8 | 220.526 | d8= | 0.197 | | | | |
| R9 | 27.287 | d9= | 0.873 | nd5 | 1.5444 | ν5 | 55.82 |
| R10 | −1.471 | d10= | 0.020 | | | | |
| R11 | 2.253 | d11= | 0.748 | nd6 | 1.6400 | ν6 | 23.54 |
| R12 | 1.062 | d12= | 0.487 | | | | |
| R13 | ∞ | d13= | 0.210 | ndg | 1.5168 | νg | 64.17 |
| R14 | ∞ | d14= | 0.733 | | | | |

Table 6 shows aspherical surface data of each lens in the camera optical lens 30 according to Example 3 of the present disclosure.

TABLE 6

| | Conic Coefficient | Aspherical Coefficient | | | | |
|---|---|---|---|---|---|---|
| | k | A4 | A6 | A8 | A10 | A12 |
| R1 | −2.59677E+01 | 2.01390E−01 | −2.88670E−02 | −4.59140E−01 | 1.13140E+00 | −1.55090E+00 |
| R2 | 2.44095E+02 | 1.04170E+00 | −3.14030E+00 | 1.41180E+01 | −5.89010E+01 | 1.85380E+02 |
| R3 | −4.08777E+00 | 3.70680E−01 | −6.84830E−01 | −4.83270E+00 | 6.20700E+01 | −3.48990E+02 |
| R4 | 4.73241E+00 | 9.36990E−02 | −9.89690E−01 | 1.34390E+01 | −1.35450E+02 | 9.34320E+02 |
| R5 | 7.29933E+00 | −5.36750E−02 | 1.26240E+00 | −2.90090E+01 | 3.27150E+02 | −1.69120E+03 |
| R6 | 3.01474E−01 | −2.29840E−01 | 7.75180E−01 | −1.29650E+01 | 1.27300E+02 | −8.24170E+02 |
| R7 | 1.71133E+01 | −3.26250E−01 | 1.24400E+00 | −2.52150E+01 | 2.46420E+02 | −1.46680E+03 |
| R8 | 3.83835E+04 | 7.00390E−02 | −1.48420E+00 | 3.58780E+00 | 3.11360E+00 | −5.16720E+01 |
| R9 | 6.55561E+01 | 4.23100E−01 | −1.26850E+00 | 2.41160E+00 | −3.33520E+00 | 3.44500E+00 |
| R10 | −2.19920E+00 | 2.69500E−01 | −5.32900E−01 | 1.15000E+00 | −2.02880E+00 | 2.47990E+00 |
| R11 | −1.59371E−02 | −9.68490E−02 | −3.29800E−01 | 1.02690E+00 | −1.91380E+00 | 2.38750E+00 |
| R12 | −4.36092E+00 | −1.20060E−01 | 1.28100E−01 | −1.30360E−01 | 9.75380E−02 | −5.20060E−02 |

| | Conic Coefficient | Aspherical Coefficient | | | | |
|---|---|---|---|---|---|---|
| | k | A14 | A16 | A18 | A20 | A22 |
| R1 | −2.59677E+01 | 1.42130E+00 | −9.16020E−01 | 4.21470E−01 | −1.37880E−01 | 3.13470E−02 |
| R2 | 2.44095E+02 | −4.25430E+02 | 7.10900E+02 | −8.62870E+02 | 7.51770E+02 | −4.57570E+02 |
| R3 | −4.08777E+00 | 1.21910E+03 | −2.86800E+03 | 4.67360E+03 | −5.29130E+03 | 4.08620E+03 |
| R4 | 4.73241E+00 | −4.37300E+03 | 1.39780E+04 | −3.04730E+04 | 4.45360E+04 | −4.17580E+04 |
| R5 | 7.29933E+00 | −1.59720E+03 | 7.69430E+04 | −4.93190E+05 | 1.64950E+06 | −3.18250E+06 |
| R6 | 3.01474E−01 | 3.68880E+03 | −1.17090E+04 | 2.65460E+04 | −4.26680E+04 | 4.74720E+04 |
| R7 | 1.71133E+01 | 5.90630E+03 | −1.67390E+04 | 3.38010E+04 | −4.83700E+04 | 4.79110E+04 |
| R8 | 3.83835E+04 | 1.96730E+02 | −4.49380E+02 | 6.90600E+02 | −7.31030E+02 | 5.26510E+02 |
| R9 | 6.55561E+01 | −2.65590E+00 | 1.51670E+00 | −6.34260E−01 | 1.90420E−01 | −3.95520E−02 |
| R10 | −2.19920E+00 | −2.08990E+00 | 1.24870E+00 | −5.39440E−01 | 1.68520E−01 | −3.71930E−02 |
| R11 | −1.59371E−02 | −2.07200E+00 | 1.27700E+00 | −5.60860E−01 | 1.73560E−01 | −3.68200E−02 |
| R12 | −4.36092E+00 | 1.98150E−02 | −5.39120E−03 | 1.03890E−03 | −1.39310E−04 | 1.25720E−05 |

| | Conic Coefficient | Aspherical Coefficient | | | | |
|---|---|---|---|---|---|---|
| | k | A24 | A26 | A28 | A30 | / |
| R1 | −2.59677E+01 | −4.71160E−03 | 4.21160E−04 | −1.69640E−05 | 1.76230E−10 | / |
| R2 | 2.44095E+02 | 1.84500E+02 | −4.42200E+01 | 4.76270E+00 | 3.15520E−05 | / |
| R3 | −4.08777E+00 | −2.05330E+03 | 6.05340E+02 | −7.94810E+01 | −2.32470E−03 | / |
| R4 | 4.73241E+00 | 2.27490E+04 | −5.49950E+03 | −1.57440E+00 | −9.10050E−01 | / |
| R5 | 7.29933E+00 | 3.35910E+06 | −1.50770E+06 | 1.20870E+01 | 9.47270E+02 | / |
| R6 | 3.01474E−01 | −3.47620E+04 | 1.50730E+04 | −2.93290E+03 | −2.36580E−03 | / |
| R7 | 1.71133E+01 | −3.12210E+04 | 1.20330E+04 | −2.07730E+03 | 9.53020E−02 | / |
| R8 | 3.83835E+04 | −2.46600E+02 | 6.77350E+01 | −8.27920E+00 | −4.58750E−05 | / |
| R9 | 6.55561E+01 | 5.29480E−03 | −3.94830E−04 | 1.12710E−05 | 1.18150E−08 | / |
| R10 | −2.19920E+00 | 5.49000E−03 | −4.84510E−04 | 1.92620E−05 | 6.03390E−10 | / |
| R11 | −1.59371E−02 | 5.08110E−03 | −4.09960E−04 | 1.46550E−05 | −4.41430E−11 | / |
| R12 | −4.36092E+00 | −7.17550E−07 | 2.28390E−08 | −2.94710E−10 | 4.97550E−15 | / |

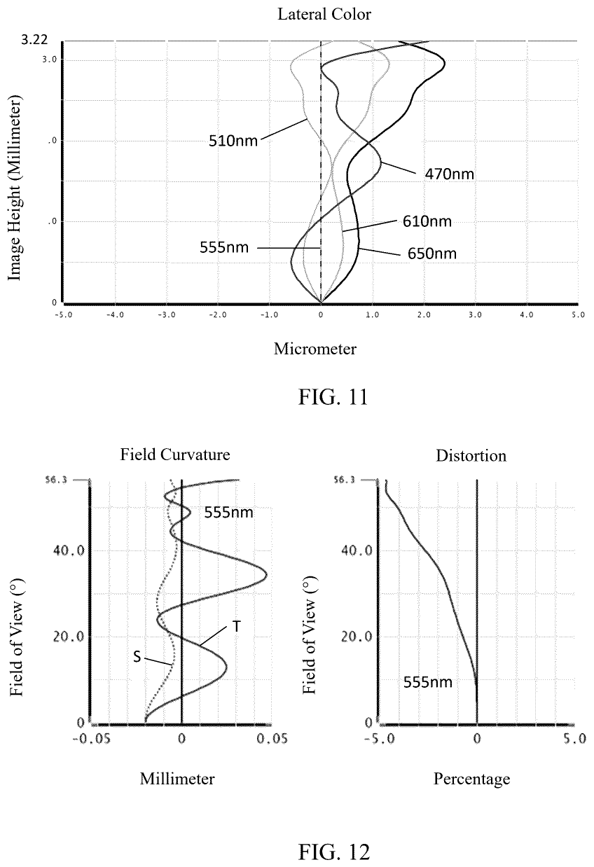

FIG. 10 and FIG. 11 respectively show longitudinal aberration and lateral color of light with wavelengths of 650 nm, 610 nm, 555 nm, 510 nm, and 470 nm after passing through the camera optical lens 30 according to Example 3. FIG. 12 shows field curvature and distortion of light with a wavelength of 555 nm after passing through the camera optical lens 30 according to Example 3. The field curvature S in FIG. 12 is the field curvature in the sagittal direction, and T is the field curvature in the meridian direction.

In this example, the entrance pupil diameter ENPD of the camera optical lens 30 is 1.017 mm, the full field of view (1.0 field of view) image height IH is 3.222 mm, and the field of view FOV in the diagonal direction of the full field of view (1.0 field of view) is 112.66°; the camera optical lens 30 meets the design requirements of large aperture, wide-angle and ultra-thinness, and the on-axis and off-axis chromatic aberration thereof are fully corrected. The camera optical lens 30 has good optical characteristics.

### Example 4

The meaning of the reference signs of Example 4 is the same as that of Example 1.

FIG. 13 shows a camera optical lens 40 according to Example 4 of the present disclosure.

Table 7 and Table 8 show design data of the camera optical lens 40 according to Example 4 of the present disclosure.

TABLE 7

| | R | d | | nd | | νd | |
|---|---|---|---|---|---|---|---|
| S1 | ∞ | d0= | −1.506 | | | | |
| R1 | −1.783 | d1= | 0.404 | nd1 | 1.5444 | ν1 | 55.82 |
| R2 | −13.882 | d2= | 0.327 | | | | |
| R3 | 1.777 | d3= | 0.345 | nd2 | 1.6153 | ν2 | 25.94 |
| R4 | 2.331 | d4= | 0.417 | | | | |
| R5 | 2.818 | d5= | 0.743 | nd3 | 1.5444 | ν3 | 55.82 |
| R6 | −2.142 | d6= | 0.244 | | | | |
| R7 | −4.702 | d7= | 0.274 | nd4 | 1.6700 | ν4 | 19.39 |
| R8 | 215.359 | d8= | 0.218 | | | | |
| R9 | 13.605 | d9= | 0.917 | nd5 | 1.5444 | ν5 | 55.82 |
| R10 | −1.712 | d10= | 0.037 | | | | |
| R11 | 2.156 | d11= | 0.746 | nd6 | 1.6400 | ν6 | 23.54 |
| R12 | 1.059 | d12= | 0.493 | | | | |
| R13 | ∞ | d13= | 0.210 | ndg | 1.5168 | νg | 64.17 |
| R14 | ∞ | d14= | 0.350 | | | | |

Table 8 shows aspherical surface data of each lens in the camera optical lens 40 according to Example 4 of the present disclosure.

TABLE 8

| | Conic Coefficient | Aspherical Coefficient | | | | |
|---|---|---|---|---|---|---|
| | k | A4 | A6 | A8 | A10 | A12 |
| R1 | −2.71628E+01 | 2.01520E−01 | −2.89820E−02 | −4.59140E−01 | 1.13140E+00 | −1.55090E+00 |
| R2 | 8.67486E+01 | 1.04190E+00 | −3.13840E+00 | 1.41200E+01 | −5.89000E+01 | 1.85380E+02 |
| R3 | −4.02132E+00 | 3.73030E−01 | −6.84710E−01 | −4.83160E+00 | 6.20710E+01 | −3.48990E+02 |
| R4 | 4.75104E+00 | 8.99450E−02 | −1.00550E+00 | 1.34170E+01 | −1.35430E+02 | 9.34440E+02 |
| R5 | 5.73758E+00 | −7.76220E−02 | 1.26470E+00 | −2.89860E+01 | 3.27170E+02 | −1.69130E+03 |
| R6 | 1.83749E−01 | −2.26850E−01 | 7.65350E−01 | −1.29830E+01 | 1.27290E+02 | −8.24180E+02 |
| R7 | 1.91957E+01 | −3.39500E−01 | 1.24040E+00 | −2.52150E+01 | 2.46430E+02 | −1.46680E+03 |
| R8 | 3.95226E+04 | 7.25410E−02 | −1.48210E+00 | 3.59000E+00 | 3.11580E+00 | −5.16700E+01 |
| R9 | 5.60037E+00 | 4.22030E−01 | −1.26860E+00 | 2.41150E+00 | −3.33520E+00 | 3.44500E+00 |
| R10 | −2.37479E+00 | 2.73200E−01 | −5.32190E−01 | 1.14990E+00 | −2.02880E+00 | 2.47990E+00 |
| R11 | 2.15312E−03 | −1.00070E−01 | −3.29450E−01 | 1.02730E+00 | −1.91380E+00 | 2.38750E+00 |
| R12 | −4.04750E+00 | −1.21830E−01 | 1.28710E−01 | −1.30340E−01 | 9.75300E−02 | −5.20070E−02 |

| | |
|---|---|
| Conic Coefficient | Aspherical Coefficient |

| | k | A14 | A16 | A18 | A20 | A22 |
|---|---|---|---|---|---|---|
| R1 | −2.71628E+01 | 1.42130E+00 | −9.16020E−01 | 4.21470E−01 | −1.37880E−01 | 3.13470E−02 |
| R2 | 8.67486E+01 | −4.25430E+02 | 7.10900E+02 | −8.62870E+02 | 7.51770E+02 | −4.57570E+02 |
| R3 | −4.02132E+00 | 1.21910E+03 | −2.86800E+03 | 4.67360E+03 | −5.29120E+03 | 4.08620E+03 |
| R4 | 4.75104E+00 | −4.37290E+03 | 1.39780E+04 | −3.04730E+04 | 4.45360E+04 | −4.17580E+04 |
| R5 | 5.73758E+00 | −1.59750E+03 | 7.69420E+04 | −4.93190E+05 | 1.64950E+06 | −3.18250E+06 |
| R6 | 1.83749E−01 | 3.68880E+03 | −1.17090E+04 | 2.65460E+04 | −4.26680E+04 | 4.74720E+04 |
| R7 | 1.91957E+01 | 5.90630E+03 | −1.67390E+04 | 3.38010E+04 | −4.83700E+04 | 4.79110E+04 |
| R8 | 3.95226E+04 | 1.96730E+02 | −4.49380E+02 | 6.90600E+02 | −7.31030E+02 | 5.26510E+02 |
| R9 | 5.60037E+00 | −2.65590E+00 | 1.51670E+00 | −6.34260E−01 | 1.90420E−01 | −3.95520E−02 |
| R10 | −2.37479E+00 | −2.08990E+00 | 1.24870E+00 | −5.39440E−01 | 1.68520E−01 | −3.71930E−02 |
| R11 | 2.15312E−03 | −2.07200E+00 | 1.27700E+00 | −5.60860E−01 | 1.73560E−01 | −3.68200E−02 |
| R12 | −4.04750E+00 | 1.98150E−02 | −5.39120E−03 | 1.03890E−03 | −1.39310E−04 | 1.25720E−05 |

| | Conic Coefficient | Aspherical Coefficient | | | | |
|---|---|---|---|---|---|---|
| | k | A24 | A26 | A28 | A30 | / |
| R1 | −2.71628E+01 | −4.71160E−03 | 4.21160E−04 | −1.69650E−05 | 1.06640E−10 | / |
| R2 | 8.67486E+01 | 1.84500E+02 | −4.42200E+01 | 4.76270E+00 | −1.47070E−06 | / |
| R3 | −4.02132E+00 | −2.05330E+03 | 6.05340E+02 | −7.94800E+01 | −3.53700E−03 | / |
| R4 | 4.75104E+00 | 2.27490E+04 | −5.49870E+03 | 2.77390E+00 | 6.60750E+00 | / |
| R5 | 5.73758E+00 | 3.35910E+06 | −1.50760E+06 | 2.06950E+02 | 9.23390E+02 | / |
| R6 | 1.83749E−01 | −3.47620E+04 | 1.50730E+04 | −2.93300E+03 | −1.99400E−01 | / |
| R7 | 1.91957E+01 | −3.12210E+04 | 1.20330E+04 | −2.07740E+03 | −1.27180E−01 | / |
| R8 | 3.95226E+04 | −2.46600E+02 | 6.77350E+01 | −8.27930E+00 | −1.65610E−04 | / |
| R9 | 5.60037E+00 | 5.29480E−03 | −3.94850E−04 | 1.12550E−05 | 2.19880E−10 | / |
| R10 | −2.37479E+00 | 5.49000E−03 | −4.84520E−04 | 1.92610E−05 | 2.52380E−11 | / |
| R11 | 2.15312E−03 | 5.08110E−03 | −4.09960E−04 | 1.46550E−05 | −5.26840E−12 | / |
| R12 | −4.04750E+00 | −7.17550E−07 | 2.28400E−08 | −2.94720E−10 | 3.68100E−16 | / |

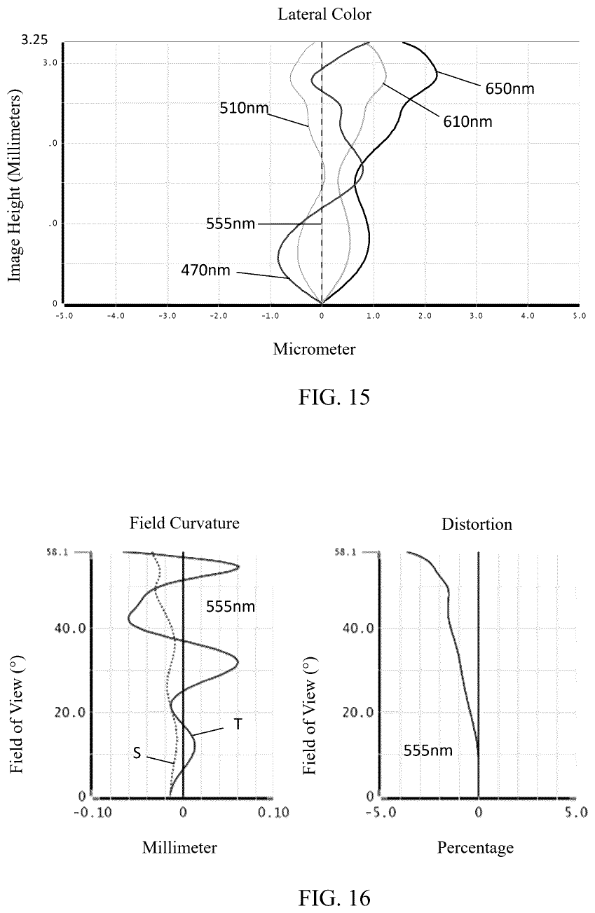

FIG. 14 and FIG. 15 respectively show longitudinal aberration and lateral color of light with wavelengths of 650 nm, 610 nm, 555 nm, 510 nm, and 470 nm after passing through the camera optical lens 40 according to Example 4. FIG. 16 shows field curvature and distortion of light with a wavelength of 555 nm after passing through the camera optical lens 40 according to Example 4. The field curvature S in FIG. 16 is the field curvature in the sagittal direction, and T is the field curvature in the meridian direction.

In this example, the pupil entering diameter ENPD of the camera optical lens 40 is 0.948 mm, the full field of view (1.0 field of view) image height IH is 3.249 mm, and the field of view FOV in the diagonal direction of the full field of view (1.0 field of view) is 116.30°; the camera optical lens 40 meets the design requirements of large aperture, wide-angle and ultra-thinness, and the on-axis and off-axis chromatic aberration thereof are fully corrected. The camera optical lens 40 has good optical characteristics.

### COMPARATIVE EXAMPLE

The meaning of the reference signs of Comparative Example is the same as that of Example 1.

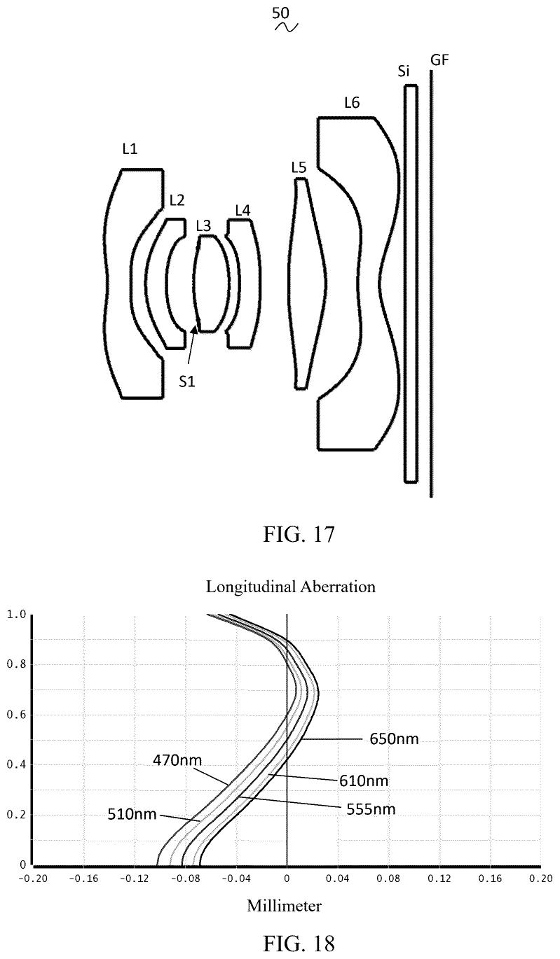

FIG. 17 shows a camera optical lens 50 according to Comparative Example in the present disclosure.

Table 9 and Table 10 show design data of the camera optical lens 50 according to Comparative Example in the present disclosure.

TABLE 9

| | R | d | | nd | | νd | |
|---|---|---|---|---|---|---|---|
| S1 | ∞ | d0= | −1.578 | | | | |
| R1 | −1.661 | d1= | 0.406 | nd1 | 1.5444 | ν1 | 55.82 |
| R2 | −59.179 | d2= | 0.257 | | | | |
| R3 | 1.713 | d3= | 0.360 | nd2 | 1.6153 | ν2 | 25.94 |
| R4 | 1.902 | d4= | 0.478 | | | | |
| R5 | 2.348 | d5= | 0.618 | nd3 | 1.5444 | ν3 | 55.82 |
| R6 | −2.010 | d6= | 0.179 | | | | |
| R7 | −3.545 | d7= | 0.363 | nd4 | 1.6700 | ν4 | 19.39 |
| R8 | −5.342 | d8= | 0.496 | | | | |
| R9 | 24.614 | d9= | 0.647 | nd5 | 1.5444 | ν5 | 55.82 |
| R10 | −1.630 | d10= | 0.558 | | | | |
| R11 | 2.876 | d11= | 0.377 | nd6 | 1.6400 | ν6 | 23.54 |
| R12 | 1.105 | d12= | 0.444 | | | | |
| R13 | ∞ | d13= | 0.210 | ndg | 1.5168 | νg | 64.17 |
| R14 | ∞ | d14= | 0.247 | | | | |

Table 10 shows aspherical surface data of each lens in the camera optical lens 50 according to Comparative Example in the present disclosure.

TABLE 10

| | Conic Coefficient | Aspherical Coefficient | | | | |
|---|---|---|---|---|---|---|
| | k | A4 | A6 | A8 | A10 | A12 |
| R1 | −2.33901E+01 | 2.01710E−01 | −2.89170E−02 | −4.59150E−01 | 1.13140E+00 | −1.55090E+00 |
| R2 | 8.78628E+01 | 1.04540E+00 | −3.14000E+00 | 1.41170E+01 | −5.89010E+01 | 1.85380E+02 |
| R3 | −3.85806E+00 | 3.73160E−01 | −6.85440E−01 | −4.83310E+00 | 6.20710E+01 | −3.48990E+02 |
| R4 | 4.78746E+00 | 8.64880E−02 | −9.88810E−01 | 1.34500E+01 | −1.35420E+02 | 9.34350E+02 |
| R5 | 7.20653E+00 | −6.04700E−02 | 1.27960E+00 | −2.89750E+01 | 3.27150E+02 | −1.69130E+03 |
| R6 | −8.54834E−02 | −2.23530E−01 | 7.90300E−01 | −1.29600E+01 | 1.27310E+02 | −8.24160E+02 |
| R7 | 1.73409E+01 | −3.27460E−01 | 1.24170E+00 | −2.52120E+01 | 2.46430E+02 | −1.46680E+03 |
| R8 | −9.90000E+01 | 6.99180E−02 | −1.48420E+00 | 3.58710E+00 | 3.11300E+00 | −5.16720E+01 |
| R9 | 3.67473E+00 | 4.22480E−01 | −1.26860E+00 | 2.41150E+00 | −3.33520E+00 | 3.44500E+00 |
| R10 | −2.38291E+00 | 2.73080E−01 | −5.32270E−01 | 1.14990E+00 | −2.02880E+00 | 2.47990E+00 |
| R11 | 2.51965E−03 | −1.00160E−01 | −3.29410E−01 | 1.02730E+00 | −1.91380E+00 | 2.38750E+00 |
| R12 | −4.28680E+00 | −1.22580E−01 | 1.28570E−01 | −1.30350E−01 | 9.75300E−02 | −5.20070E−02 |

| | Conic Coefficient | Aspherical Coefficient | | | | |
|---|---|---|---|---|---|---|
| | k | A14 | A16 | A18 | A20 | A22 |
| R1 | −2.33901E+01 | 1.42130E+00 | −9.16020E−01 | 4.21470E−01 | −1.37880E−01 | 3.13470E−02 |
| R2 | 8.78628E+01 | −4.25430E+02 | 7.10900E+02 | −8.62870E+02 | 7.51770E+02 | −4.57570E+02 |
| R3 | −3.85806E+00 | 1.21910E+03 | −2.86800E+03 | 4.67360E+03 | −5.29130E+03 | 4.08620E+03 |
| R4 | 4.78746E+00 | −4.37300E+03 | 1.39780E+04 | −3.04730E+04 | 4.45360E+04 | −4.17580E+04 |
| R5 | 7.20653E+00 | −1.59730E+03 | 7.69430E+04 | −4.93190E+05 | 1.64950E+06 | −3.18250E+06 |
| R6 | −8.54834E−02 | 3.68880E+03 | −1.17090E+04 | 2.65460E+04 | −4.26680E+04 | 4.74720E+04 |
| R7 | 1.73409E+01 | 5.90630E+03 | −1.67390E+04 | 3.38010E+04 | −4.83700E+04 | 4.79110E+04 |
| R8 | −9.90000E+01 | 1.96730E+02 | −4.49380E+02 | 6.90600E+02 | −7.31030E+02 | 5.26510E+02 |
| R9 | 3.67473E+00 | −2.65590E+00 | 1.51670E+00 | −6.34260E−01 | 1.90420E−01 | −3.95520E−02 |
| R10 | −2.38291E+00 | −2.08990E+00 | 1.24870E+00 | −5.39440E−01 | 1.68520E−01 | −3.71930E−02 |
| R11 | 2.51965E−03 | −2.07200E+00 | 1.27700E+00 | −5.60860E−01 | 1.73560E−01 | −3.68200E−02 |
| R12 | −4.28680E+00 | 1.98150E−02 | −5.39120E−03 | 1.03890E−03 | −1.39310E−04 | 1.25720E−05 |

| | Conic Coefficient | Aspherical Coefficient | | | | |
|---|---|---|---|---|---|---|
| | k | A24 | A26 | A28 | A30 | / |
| R1 | −2.33901E+01 | −4.71160E−03 | 4.21160E−04 | −1.69650E−05 | / | / |
| R2 | 8.78628E+01 | 1.84500E+02 | −4.42200E+01 | 4.76260E+00 | / | / |
| R3 | −3.85806E+00 | −2.05330E+03 | 6.05340E+02 | −7.94780E+01 | / | / |
| R4 | 4.78746E+00 | 2.27490E+04 | −5.49930E+03 | 0.00000E+00 | / | / |
| R5 | 7.20653E+00 | 3.35920E+06 | −1.50760E+06 | 0.00000E+00 | / | / |
| R6 | −8.54834E−02 | −3.47620E+04 | 1.50730E+04 | −2.93290E+03 | / | / |
| R7 | 1.73409E+01 | −3.12210E+04 | 1.20330E+04 | −2.07730E+03 | / | / |
| R8 | −9.90000E+01 | −2.46600E+02 | 6.77350E+01 | −8.27920E+00 | / | / |
| R9 | 3.67473E+00 | 5.29480E−03 | −3.94850E−04 | 1.12550E−05 | / | / |
| R10 | −2.38291E+00 | 5.49000E−03 | −4.84520E−04 | 1.92610E−05 | / | / |
| R11 | 2.51965E−03 | 5.08110E−03 | −4.09960E−04 | 1.46550E−05 | / | / |
| R12 | −4.28680E+00 | −7.17550E−07 | 2.28400E−08 | −2.94720E−10 | / | / |

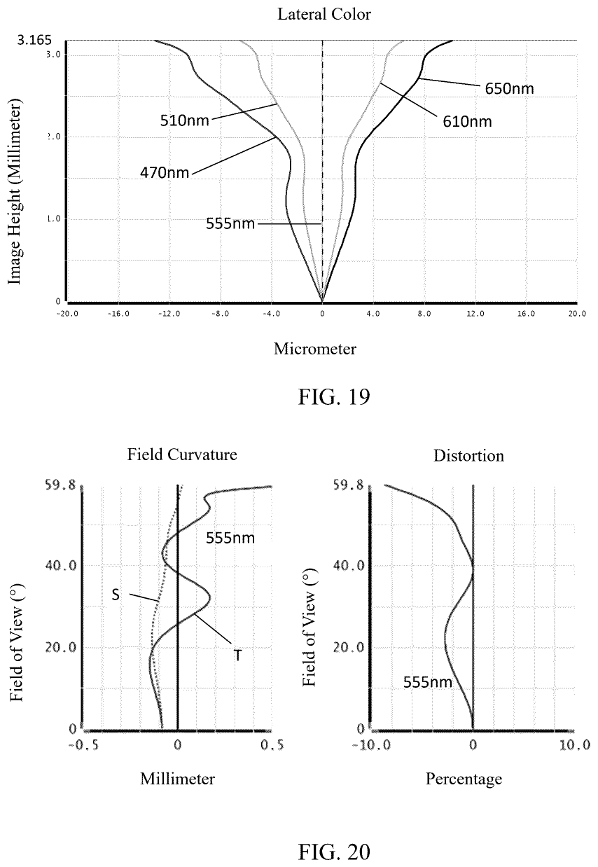

FIG. 18 and FIG. 19 respectively show longitudinal aberration and lateral color of light with wavelengths of 650 nm, 610 nm, 555 nm, 510 nm, and 470 nm after passing through the camera optical lens 50 according to Comparative Example. FIG. 20 shows field curvature and distortion of light with a wavelength of 555 nm after passing through the camera optical lens 50 according to Comparative Example. The field curvature S in FIG. 20 is the field curvature in the sagittal direction, and T is the field curvature in the meridian direction.

Table 11 below lists values corresponding to each relational expression in Comparative Example according to the above relational expressions. The camera optical lens 50 of Comparative Example does not satisfy the above relational expression

$$2. \leq ( d 1 + d 3 + d 5 ) / ( d 2 + d 4 ) \leq 4.5 .$$

In Comparative Example, the entrance pupil diameter ENPD of the camera optical lens 50 is 0.889 mm, the full field of view (1.0 field of view) image height IH is 3.165 mm, and the field of view FOV in the diagonal direction of the full field of view (1.0 field of view) is 119.57°; the camera optical lens 50 does not meet the design requirements of large aperture, wide-angle and ultra-thinness, and the on-axis and off-axis chromatic aberration thereof are not fully corrected. The camera optical lens 50 does not have good optical characteristics.

TABLE 11

| Parameters and | | | | | |
|---|---|---|---|---|---|
| Relational | Exam- | Exam- | Exam- | Exam- | Comparative |
| Expressions | ple 1 | ple 2 | ple 3 | ple 4 | Example |
| (f5 − f6)/f | 3.51 | 4.00 | 3.00 | 3.48 | 3.00 |
| (d1 + d3 + d5)/ | 3.24 | 4.50 | 3.31 | 2.00 | 1.88 |
| (d2 + d4) | | | | | |
| (R1 + R2)/(R1 − | −1.12 | −1.05 | −1.22 | −1.29 | −1.06 |
| R2) | | | | | |
| BF/TTL | 0.19 | 0.15 | 0.24 | 0.18 | 0.16 |
| (R9 + R10)/(R9 − | 0.77 | 0.56 | 0.90 | 0.78 | 0.88 |
| R10) | | | | | |
| f | 2.130 | 2.103 | 2.236 | 2.085 | 1.955 |
| f1 | −3.457 | −3.300 | −3.751 | −3.790 | −3.137 |
| f2 | 8.768 | 8.489 | 11.991 | 9.739 | 16.093 |
| f3 | 2.390 | 2.203 | 2.421 | 2.352 | 2.087 |
| f4 | −7.020 | −6.551 | −6.742 | −6.801 | −16.959 |
| f5 | 2.807 | 3.152 | 2.583 | 2.845 | 2.824 |
| f6 | −4.679 | −5.253 | −4.131 | −4.406 | −3.038 |
| FNO | 2.200 | 2.200 | 2.199 | 2.199 | 2.199 |
| TTL | 5.907 | 5.656 | 5.969 | 5.725 | 5.640 |

Those skilled in the art may understand that the above examples are specific embodiments for implementing the present disclosure, and in practical applications, various changes may be made in form and detail without departing from the spirit and scope of the present disclosure.

What is claimed is:

1. A camera optical lens, sequentially comprising six lenses from an object-side to an image-side: a first lens having negative refractive power, a second lens having positive refractive power, a third lens having positive refractive power, a fourth lens having negative refractive power, and a fifth lens having positive refractive power, and a sixth lens having negative refractive power;
wherein, a focal length of the camera optical lens is f, a focal length of the fifth lens is f5, a focal length of the sixth lens is f6, an on-axis thickness of the first lens is d1, an on-axis thickness of the second lens is d3, an on-axis thickness of the third lens is d5, an on-axis distance from an image-side surface of the first lens to an object-side surface of the second lens is d2, an on-axis distance from an image-side surface of the second lens to an object-side surface of the third lens is d4, a central curvature radius of an object-side surface of the first lens in a paraxial region is R1, and a central curvature radius of an image-side surface of the first lens in the paraxial region is R2, and following relational expressions are satisfied:
$$3. \leq ( f 5 - f 6 ) / f \leq 4. ; \\ 2. \leq ( d 1 + d 3 + d 5 ) / ( d 2 + d 4 ) \leq 4.5 ; and$$
$$- 1.3 \leq ( R 1 + R 2 ) / ( R 1 - R 2 ) \leq - 1.05 .$$

2. The camera optical lens as described in claim 1, wherein an on-axis distance from an image-side surface of the sixth lens to an image plane is BF; a total optical length from an object-side surface of the first lens to the image plane of the camera optical lens along an optic axis is TTL, and a following relational expression is satisfied:
$$0.15 \leq BF / TTL \leq 0.24 .$$

3. The camera optical lens as described in claim 1, wherein a central curvature radius of the object-side surface of the fifth lens in a paraxial region is R9, a central curvature radius of the image-side surface of the fifth lens in the paraxial region is R10, and a following relational expression is satisfied:
$$0.55 \leq ( R 9 + R 10 ) / ( R 9 - R 10 ) \leq 0.9 .$$

4. The camera optical lens as described in claim 1, wherein an object-side surface of the first lens is concave in a paraxial region, and an image-side surface of the first lens is convex in the paraxial region;
a focal length of the first lens is f1, and a total optical length from an object-side surface of the first lens to an image plane of the camera optical lens along an optic axis is TTL, and following relational expressions are satisfied:
$$- 3.64 \leq f 1 / f \leq - 1.05 ; and$$
$$0.03 \leq d 1 / TTL \leq 0.11 .$$

5. The camera optical lens as described in claim 1, wherein an object-side surface of the second lens is convex in a paraxial region, and an image-side surface of the second lens is concave in the paraxial region;
a focal length of the second lens is f2, a central curvature radius of an object-side surface of the second lens in a paraxial region is R3, a central curvature radius of an image-side surface of the second lens in the paraxial region is R4, and a total optical length from an object-side surface of the first lens to an image plane of the camera optical lens along an optic axis is TTL, and following relational expressions are satisfied:
$$2.02 \leq f 2 / f \leq 8.04 ; \\ - 19.49 \leq ( R 3 + R 4 ) / ( R 3 - R 4 ) \leq - 4.64 ; and$$
$$0.03 \leq d 3 / TTL \leq 0.15 .$$

6. The camera optical lens as described in claim 1, wherein an object-side surface of the third lens is convex in a paraxial region, and an image-side surface of the third lens is convex in the paraxial region;
a focal length of the third lens is f3, a central curvature radius of an object-side surface of the third lens in a paraxial region is R5, a central curvature radius of the image-side surface of the third lens in the paraxial region is R6, a total optical length from an object-side surface of the first lens to an image plane of the camera optical lens along an optic axis is TTL, and following relational expressions are satisfied:
$$0.52 \leq f 3 / f \leq 1.69 ; \\ 0.06 \leq ( R 5 + R 6 ) / ( R 5 - R 6 ) \leq 0.23 ; and$$
$$0.06 \leq d 5 / TTL \leq 0.24 .$$

7. The camera optical lens as described in claim 1, wherein an object-side surface of the fourth lens is concave in a paraxial region;
a focal length of the fourth lens is f4, a central curvature radius of an object-side surface of the fourth lens in a paraxial region is R7, a central curvature radius of an image-side surface of the fourth lens in a paraxial region is R8, an on-axis thickness of the fourth lens is d7, and a total optical length from an object-side surface of the first lens to an image plane of the camera optical lens along an optic axis is TTL, and following relational expressions are satisfied:
$$- 6.59 \leq f 4 / f \leq - 2.01 ; \\ - 2.08 \leq ( R 7 + R 8 ) / ( R 7 - R 8 ) \leq 0.64 ; \\ 0.02 \leq d 7 / TTL \leq 0.07 .$$

8. The camera optical lens as described in claim 1, wherein an object-side surface of the fifth lens is convex in a paraxial region; an image-side surface of the fifth lens is convex in the paraxial region;
an on-axis thickness of the fifth lens is d9, and a total optical length from an object-side surface of the first lens to an image plane of the camera optical lens along an optic axis is TTL, and following relational expressions are satisfied:
$$0.58 \leq f 5 / f \leq 2.25 ; and \\ 0.07 \leq d 9 / TTL \leq 0.24 .$$

9. The camera optical lens as described in claim 1, wherein an object-side surface of the sixth lens is convex in a paraxial region, and an image-side surface of the sixth lens is concave in the paraxial region;
a central curvature radius of an object-side surface of the sixth lens in a paraxial region is R11, a central curvature radius of an image-side surface of the sixth lens in the paraxial region is R12, an on-axis thickness of the sixth lens is d11, and a total optical length from an object-side surface of the first lens to an image plane of the camera optical lens along an optic axis is TTL, following relational expressions are satisfied:
$$- 5. \leq f 6 / f \leq - 1.23 ; \\ 1.39 \leq ( R 11 + R 12 ) / ( R 11 - R 12 ) \leq 4.7 ; and$$
$$0.06 \leq d 11 / TTL \leq 0.22 .$$

10. The camera optical lens as described in claim 1, wherein an aperture of the camera optical lens is FNO, and a following relational expression is satisfied: FNO≤2.27.
